(19) United States
(12) Patent Application Publication
(10) Pub. No.: US 2026/0019188 A1
(43) Pub. Date: Jan. 15, 2026

(54) MODEL IDENTIFICATION FOR ARTIFICIAL INTELLIGENCE

(71) Applicant: Lenovo (Singapore) Pte Ltd, Singapore (SG)

(72) Inventors: Vahid Pourahmadi, München (DE); Vijay Nangia, Woodridge, IL (US); Joachim Löhr, Wiesbaden (DE); Tapisha Soni, Munich (DE)

(73) Assignee: Lenovo (Singapore) Pte Ltd, Singapore (SG)

(21) Appl. No.: 18/773,188

(22) Filed: Jul. 15, 2024

(51) Int. Cl. H04L 1/00; G06N 3/0455; H04L 1/16

(52) U.S. Cl. CPC H04L 1/0033; G06N 3/0455; H04L 1/0036; H04L 1/16

(57) ABSTRACT

Various aspects of the present disclosure relate to model identification for artificial intelligence. An apparatus, such as a UE, transmits a set of test data and receives a first set of information associated with a first reference artificial intelligence model, where the first reference artificial intelligence model is associated with one or more of a decoder model of a two-sided artificial intelligence model or an encoder model of the two-sided artificial intelligence model. The apparatus performs a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.

### TECHNICAL FIELD

The present disclosure relates to wireless communications, and more specifically to artificial intelligence (AI) in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements. Several terms and/or elements may be separated by a forward slash (/) which may represent additional or alternative implementations. For instance, the phrase “A/B/C” may be interpreted as “A, B, and/or C.”

Some implementations of the method and apparatuses described herein may include a UE for wireless communication to transmit (e.g., send, communicate) a set of test data including at least one of statistics of input data for an encoder model of the UE, a first set of samples of the input data, or a second set of samples representing an expected output of a two-sided artificial intelligence model associated with the first set of samples of the input data; receive (e.g., obtain), a first set of information associated with a first reference artificial intelligence model, where the first reference artificial intelligence model is associated with one or more of a decoder model of a two-sided artificial intelligence model or an encoder model of the two-sided artificial intelligence model; and perform (e.g., execute, implement) a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.

In some implementations of the method and apparatuses for a UE described herein, the at least one processor is configured to cause the UE to perform measurements of a radio channel, and wherein the input data is associated with the measurements of the radio channel; the input data includes at least one of a representation of a measured channel matrix of a radio channel or a precoder for the radio channel; the first set of information includes one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples; the at least one processor is configured to cause the UE to perform the process to obtain the encoder model of the UE based at least in part on one or more of an instruction received from a different node or a different process executed at the UE.

In some implementations of the method and apparatuses for a UE described herein, if the first reference artificial intelligence model is associated with the encoder model of the two-sided artificial intelligence model, the at least one processor is configured to cause the UE to perform the process to obtain the encoder model of the UE based at least in part on the first set of information associated with the first reference artificial intelligence model; if the first reference artificial intelligence model is associated with the decoder model of the two-sided artificial intelligence model, the at least one processor is configured to cause the UE to perform the process to obtain the encoder model of the UE based at least in part on the first set of information associated with the first reference artificial intelligence model and the input data for the encoder model of the UE; the at least one processor is configured to cause the UE to transmit an indication of whether the UE successfully obtains the encoder model; if the UE is not able to successfully obtain the encoder model of the UE, the at least one processor is configured to cause the UE to: receive a second set of information associated with a second reference artificial intelligence model associated with a different decoder model; and perform the process to obtain the encoder model of the UE based at least in part on the second set of information and the input data; if the UE is not able to successfully obtain the encoder model of the UE, the at least one processor is configured to cause the UE to receive a message indicating an inability to train an encoder-decoder pair.

In some implementations of the method and apparatuses for a UE described herein, if the UE is not able to successfully obtain the encoder model of the UE, the at least one processor is configured to cause the UE to receive a message including an instruction to implement a fallback process.

Some implementations of the method and apparatuses described herein may include a UE for wireless communication to receive a set of information associated with at least one encoder-decoder pair of a two-sided artificial intelligence models; perform, based at least in part on the set of information associated with the encoder-decoder pairs, a verification process to determine whether a matching encoder model is available; and transmit at least a notification of a result of the verification process.

Some implementations of the method and apparatuses described herein may include a UE for wireless communication to receive information associated with an encoder model for an encoder-decoder pair of a two-sided artificial intelligence model; generate a latent representation based at least in part on the information associated with an encoder model; transmit test data generated via the latent representation and a corresponding expected output of the two-sided artificial intelligence model; and receive at least a notification indicating whether to continue to use the encoder model or use an alternative implementation.

Some implementations of the method and apparatuses described herein may further include a processor for wireless communication to transmit a set of test data including at least one of statistics of input data for an encoder model of a UE, a first set of samples of the input data, or a second set of samples representing an expected output of a two-sided artificial intelligence model associated with the first set of samples of the input data; receive a first set of information associated with a first reference artificial intelligence model, where the first reference artificial intelligence model is associated with one or more of a decoder model of a two-sided artificial intelligence model or an encoder model of the two-sided artificial intelligence model; and perform a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.

Some implementations of the method and apparatuses described herein may further include a processor for wireless communication to receive a set of information associated with at least one encoder-decoder pair of a two-sided artificial intelligence model; perform, based at least in part on the set of information associated with the encoder-decoder pair, a verification process to determine whether a matching encoder model is available; and transmit at least a notification of a result of the verification process.

Some implementations of the method and apparatuses described herein may further include a processor for wireless communication to receive information associated with an encoder model for an encoder-decoder pair of a two-sided artificial intelligence model; generate a latent representation based at least in part on the information associated with an encoder model; transmit test data generated via the latent representation and a corresponding expected output of the two-sided artificial intelligence model; and receive at least a notification indicating whether to continue to use the encoder model or use an alternative implementation.

Some implementations of the method and apparatuses described herein may further include a method performed by a UE, the method including transmitting a set of test data including at least one of statistics of input data for an encoder model of the UE, a first set of samples of the input data, or a second set of samples representing an expected output of a two-sided artificial intelligence model associated with the first set of samples of the input data; receiving a first set of information associated with a first reference artificial intelligence model, where the first reference artificial intelligence model is associated with one or more of a decoder model of a two-sided artificial intelligence model or an encoder model of the two-sided artificial intelligence model; and performing a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.

In some implementations of the method and apparatuses for a UE described herein, if the first reference artificial intelligence model is associated with the encoder model of the two-sided artificial intelligence model, the method further includes performing the process to obtain the encoder model of the UE based at least in part on the first set of information associated with the first reference artificial intelligence model; if the first reference artificial intelligence model is associated with the decoder model of the two-sided artificial intelligence model, the method further including performing the process to obtain the encoder model of the UE based at least in part on the first set of information associated with the first reference artificial intelligence model and the input data for the encoder model of the UE; transmitting an indication of whether the UE successfully obtains the encoder model; if the UE is not able to successfully obtain the encoder model of the UE, the method further includes: receiving a second set of information associated with a second reference artificial intelligence model associated with a different decoder model; and performing the process to obtain the encoder model of the UE based at least in part on the second set of information and the input data; if the UE is not able to successfully obtain the encoder model of the UE, the method further includes receiving a message indicating an inability to train an encoder-decoder pair.

In some implementations of the method and apparatuses for a UE described herein, if the UE is not able to successfully obtain the encoder model of the UE, the method further includes receiving a message including an instruction to implement a fallback process; performing measurements of a radio channel, and wherein the input data is associated with the measurements of the radio channel; the input data includes at least one of a representation of a measured channel matrix of a radio channel or a precoder for the radio channel; the first set of information includes one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples; performing the process to obtain the encoder model of the UE based at least in part on one or more of an instruction received from a different node or a different process executed at the UE.

Some implementations of the method and apparatuses described herein may further include a NE for wireless communication to receive a set of test data including at least one of statistics of input data for an encoder model of a UE, a first set of samples of the input data, or a second set of samples representing an expected output of a two-sided artificial intelligence model associated with the first set of samples of the input data; and transmit, based at least in part on the set of test data, a first set of information associated with a first reference artificial intelligence model, where the first reference artificial intelligence model is associated with one or more of a decoder model of a two-sided artificial intelligence model or an encoder model of the two-sided artificial intelligence model.

In some implementations of the method and apparatuses described herein, the at least one processor is configured to cause the network equipment to receive an indication of whether the UE is able to successfully obtain the encoder model; if the indication indicates that the UE is not able to successfully obtain the encoder model, the at least one processor is configured to cause the network equipment to transmit a second set of information associated with a second reference artificial intelligence model associated with a different decoder model; if the indication indicates that the UE is not able to successfully obtain the encoder model, the at least one processor is configured to cause the network equipment to transmit a message indicating an inability to train an encoder-decoder pair; if the indication indicates that the UE is not able to successfully obtain the encoder model, the at least one processor is configured to cause the network equipment to transmit a message including an instruction to implement a fallback process; the first set of information includes one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples; the at least one processor is configured to cause the network equipment to transmit, to the UE, an instruction to perform a process to obtain the encoder model of the UE.

Some implementations of the method and apparatuses described herein may further include a NE for wireless communication to transmit a set of information associated with at least one encoder-decoder pair of a two-sided artificial intelligence model; and receive at least a notification of a result of a verification process for an encoder model and the information associated with the encoder-decoder pair.

Some implementations of the method and apparatuses described herein may further include a NE for wireless communication to transmit information associated with an encoder model for an encoder-decoder pair of a two-sided artificial intelligence model; receive test data generated via a latent representation and the corresponding expected output of the two-sided model; and transmit at least a notification indicating whether to continue to use the encoder model or use an alternative implementation.

Some implementations of the method and apparatuses described herein may further include a method performed by a NE, the method including receiving a set of test data including at least one of statistics of input data for an encoder model of a UE, a first set of samples of the input data, or a second set of samples representing an expected output of a two-sided artificial intelligence model associated with the first set of samples of the input data; and transmitting, based at least in part on the set of test data, a first set of information associated with a first reference artificial intelligence model, where the first reference artificial intelligence model is associated with one or more of a decoder model of a two-sided artificial intelligence model or an encoder model of the two-sided artificial intelligence model.

In some implementations of the method and apparatuses described herein, the method further comprising receiving an indication of whether the UE is able to successfully obtain the encoder model; if the indication indicates that the UE is not able to successfully obtain the encoder model, the method further includes transmitting a second set of information associated with a second reference artificial intelligence model associated with a different decoder model; if the indication indicates that the UE is not able to successfully obtain the encoder model, the method further includes transmitting a message indicating an inability to train an encoder-decoder pair; if the indication indicates that the UE is not able to successfully obtain the encoder model, the method further includes transmitting a message including an instruction to implement a fallback process; the first set of information includes one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples; transmitting, to the UE, an instruction to perform a process to obtain the encoder model of the UE.

Some implementations of the method and apparatuses described herein may further include a method performed by a NE, the method including transmitting information associated with an encoder-decoder pair of a two-sided artificial intelligence model; and receiving a notification of a result of a verification process for an encoder model and the information associated with the encoder-decoder pair.

Some implementations of the method and apparatuses described herein may further include a method performed by a NE, the method including transmitting information associated with an encoder model for an encoder-decoder pair of a two-sided artificial intelligence model; receiving test data generated via a latent representation; and transmitting a notification indicating a performance of the test data

### BRIEF DESCRIPTION OF THE DRAWINGS

FIG. 1 illustrates an example of a wireless communications system in accordance with aspects of the present disclosure.

FIG. 2 illustrates a wireless network 200 including a base station (e.g., gNB) and multiple UEs.

FIG. 3 illustrates a high-level structure of a two-sided model 300.

FIG. 4 illustrates an example signaling diagram 400 in accordance with aspects of the present disclosure.

FIG. 5 illustrates an example signaling diagram 500 in accordance with aspects of the present disclosure.

FIG. 6 illustrates an example signaling diagram 600 in accordance with aspects of the present disclosure.

FIG. 7 illustrates an example signaling diagram 700 in accordance with aspects of the present disclosure.

FIG. 8 illustrates an example signaling diagram 800 in accordance with aspects of the present disclosure.

FIG. 9 illustrates an example signaling diagram 900 in accordance with aspects of the present disclosure.

FIG. 10 illustrates an example signaling diagram 1000 in accordance with aspects of the present disclosure.

FIG. 11 illustrates an example signaling diagram 1100 in accordance with aspects of the present disclosure.

FIG. 12 illustrates an example signaling diagram 1200 in accordance with aspects of the present disclosure.

FIG. 13 illustrates an example of a UE 1300 in accordance with aspects of the present disclosure.

FIG. 14 illustrates an example of a processor 1400 in accordance with aspects of the present disclosure.

FIG. 15 illustrates an example of a NE 1500 in accordance with aspects of the present disclosure.

FIG. 16 illustrates a flowchart of a method 1600 in accordance with aspects of the present disclosure.

FIG. 17 illustrates a flowchart of a method 1700 in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. Wireless communications systems can utilize artificial intelligence (AI) and machine learning (ML) (AI/ML, hereinafter referred to as “AI”) for a variety of different purposes, such as for network operation, network optimization, automated processing (e.g., self-driving cars in vehicle to everything (V2X) scenarios), network planning, security information and event management (SIEM)), etc. AI can leverage AI models (which may be referred to herein as “models”) which represent programs and/or algorithms trained on a set of data to provide outputs, such as to recognize patterns, make decisions, generate content, etc. AI models, for instance, can apply different algorithms to data inputs to provide data output for performing different tasks.

AI models in wireless communications systems can be implemented in a variety of configurations. For instance, models can be implemented at the UE side, NE side, or at both UE and NE sides. For instance, a two sided model represents an AI model that includes AI functionality at both the UE and NE sides. Implementing a two sided model involves a number of challenges, such as identifying encoder-decoder pairs that are able to cooperate between the UE and the NE as well as generating and maintaining training data that can maintain cooperative functionality between different sides of a two sided AI model.

The present disclosure provide solutions to enable correlation of AI model portions (e.g., encoders and decoders) between different nodes for two sided AI models. The described implementations, however, are not limited to two sided AI models and may be applicable to scenarios where more than two portions of AI models are implemented across different wireless network nodes. For instance, consider a scenario involving a first node (e.g., UE) and a second node (e.g., NE) implement different portions of a two sided model. The second node (e.g., a gNB) may have access to one or more decoder models trained based on one or more training datasets associated with a set of statistics. This disclosure describes, among other solutions, implementations for determining an encoder model which matches the decoder model to be used at the second node (e.g., NE) side. A “match” between an encoder and a decoder, for instance, represents a decoder that is configured to provide an accurate decoded version of encoded data received from an encoder. For instance, a decoder can be a “match” for an encoder when the decoder can accurately decode encoded data (e.g., within a threshold accuracy) that was encoded by the encoder, and vice-versa.

Implementations provide for a model validity check at the second node. For instance, a first node transmits test data to the second node which can be used by the second node to determine to transmit model information regarding the encoder or the decoder model to the first node. Further, a model validity check can be performed at the first node where the second node transmits information regarding different models to the first node. The first node can use the information to determine which models (if any) are a correct match based on the current input data, and the first node can query for the encoder/decoder of a corresponding two-sided model.

Implementations also provide a delayed model validity checks where the second node transmits an encoder to the first node and the first node uses the encoder for encoding a message. The first node transmits the encoded message to the second node along with information regarding an expected output from decoding the encoded message. The second node can determine the validity of a two-sided model based on whether decoding of the encoded message matches the expected output, and if needed the second node can request a change in the encoder model. Some fallback procedures are also provided, such as for scenarios where the first node and/or the second node determines that a two-sided model cannot be generated that provides satisfactory performance.

By performing the described techniques, devices in a wireless communications system can utilize AI to efficiently perform various tasks for operation of the wireless communications system.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

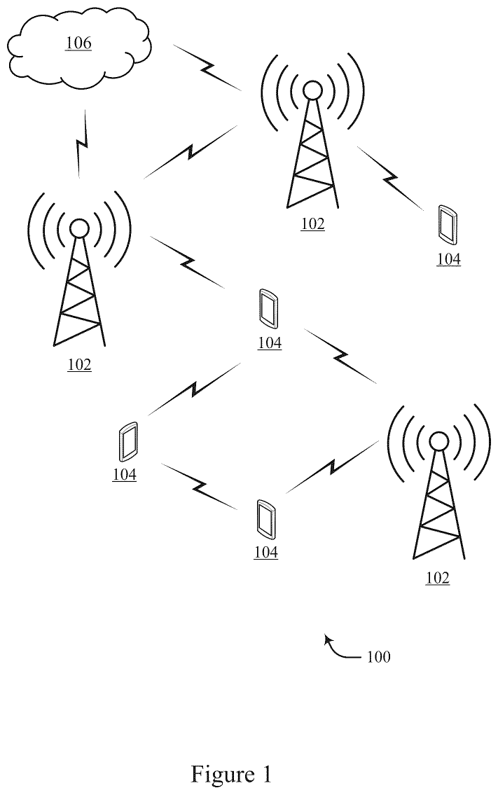

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 can transmit to a NE 102 a set of test data comprising at least one of statistics of input data for an encoder model of the UE, a first set of samples of the input data, or a second set of samples representing an expected output of a two-sided artificial intelligence model associated with the first set of samples of the input data. The UE 104 can receive from the NE 102 a first set of information associated with a first reference artificial intelligence model, where the first reference artificial intelligence model is associated with one or more of a decoder model of a two-sided artificial intelligence model or an encoder model of the two-sided artificial intelligence model. The UE 104 can perform a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

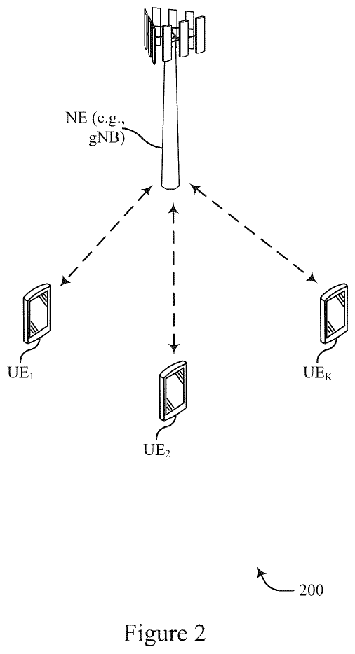

FIG. 2 illustrates a wireless network 200 including a NE and multiple UEs. The UEs, for instance, include a UE₁, UE₂, and UE_{K}. The base station can be represented as a node B₁ equipped with M antennas and the K UEs denoted by U₁, U₂, . . . , UK with each having N antennas.

$${H}_{l}^{k} ( t )$$

can denote a channel at time t over a frequency band l, l∈{1, 2, . . . , L}, between B₁ and Uₖ which is a matrix of size N×M with complex entries, i.e.,

$${H}_{l}^{k} ( t ) ∈ {ℂ}^{N \times M} .$$

At time t and frequency band l, it can be assumed that the base station is to transmit a message

$${x}_{l}^{k} ( t )$$

to U_{K}, where K={1,2, . . . K} while the base station uses

$${w}_{l}^{k} ( t ) ∈ {ℂ}^{M \times 1}$$

as the precoding vector. The received signal at Uₖ,

$${y}_{l}^{k} ( t ) ,$$

can be indicated as:

$${y}_{l}^{k} ( t ) = {H}_{l}^{k} ( t ) {w}_{l}^{k} ( t ) {x}_{l}^{k} ( t ) + {n}_{l}^{k} ( t )$$

where

$${n}_{l}^{k} ( t )$$

represents the noise vector at the receiver.

To attempt to improve the achievable rate of the link, the base station can select

$${w}_{l}^{k} ( t )$$

that maximizes the received Signal-to-Noise Ratio (SNR). Several schemes have been proposed for selection of

$${w}_{l}^{k} ( t )$$

where some rely on having some knowledge about

$${H}_{l}^{k} ( t ) .$$

The base station can obtain knowledge of by

$${H}_{l}^{k} ( t )$$

direct measurement (e.g., in Time-Division Duplexing (TDD) mode and assuming reciprocity of the channel) or indirectly using information that the UE sends to the base station (e.g., in Frequency-Division Duplexing (FDD) mode). In the latter case, a large amount of feedback may be needed to send accurate information about

$${H}_{l}^{k} ( t ) .$$

In the description herein, implementations are discussed with reference to a single time slot, but implementations can be further extended to more than a single time slot. Thus,

$${H}_{l}^{k} ( t )$$

can be denoted using

$${H}_{l}^{k} .$$

H^{k}(t) can be defined as matrix of size N×M×L which can be composed by stacking

$${H}_{l}^{k}$$

for multiple frequency bands, e.g., the entries at H^{k}[n, m, l](t) can be equal to

$${H}_{l}^{k} [ n , m ] ( t ) .$$

Thus, each UE can be feeding back the information about the most recent N×M×L complex numbers to the base station.

Several methods have been proposed to attempt to reduce the rate of required feedback. For instance, a group of these methods include two parts where a first part is deployed at the UE side and the second part is deployed at the base station side. The UE and base station sides include one or more neural network blocks which are trained using data driven approaches. The UE side can compute a latent representation of input data (e.g., to be transferred to the base station), such as with as low number of bits as possible. The base station can receive data transmitted by the UE side, and the base station can attempt to reconstruct the information intended by the UE to be transmitted to the base station.

The input data in such cases can be data which is based on the channel measurements. For example, the input data can be the raw channel inputs of H^{k} or

$${H}_{l}^{k} ,$$

precoders that are computed from the channel matrix, e.g., the eigenvector associated to the largest eigen-vector of H^{k} for each subband.

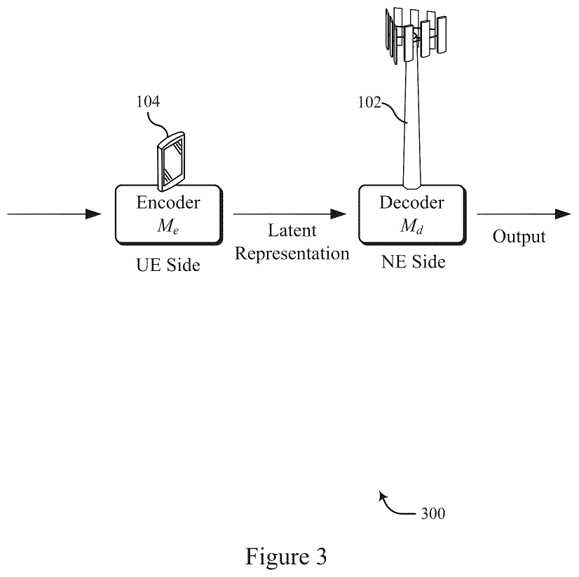

FIG. 3 illustrates a high-level structure of a two-sided model 300. The two-sided model 300 includes a with neural network-based UE and NE sides referred to here as Mₑ (encoding model) and M_{d} (decoding model), respectively. The input of the model is based on the channel measurement, can be for example be raw channel measurement, or eigenvectors associated to the measured channel. The structure of the UE and NE side can vary depending on the particular scheme. There also several schemes to train the encoder and decoder model, e.g., simultaneous training and separate training. The applicability of a trained model may be based on a type of data it has observed during the training stage with some generalization ability that the model also learned.

To improve the accuracy of the developed model, it is also common to train multiple models (instead of on one model with high generalization capability) for different clusters of a dataset where different clusters represent different statistics/behaviour of the input data or input/output relationship. There are several methods to train the encoder/decoder modules of a two-sided model, including centralized training, simultaneous training, and separate training. Similarly, updating a two-sided model can be carried out centrally on one entity, on different entities, simultaneously, or separately. In separate training/model update, the NN modules of the first node (e.g., UE) and the second node (e.g., NE) can be trained in different training sessions, e.g., with no forward or backpropagation path between the two parts. One advantage of the separate training is that the first and the second node does not need to be aware of the internal structure of the NN module of the other side.

Several schemes have been identified for identifying a correct encoder/decoder pair a two-sided models. One option is that each first node and second node develops one or more encoder-decoder pairs together. Then during inference time, the UE and the NE can determine the correct pair when the UE and NE determine the other side's identity and, if needed, network configuration and UE/NE additional conditions. The main drawback of this scheme is the inter-vendor collaboration complexity needed for training of different models for each pair of first and second nodes.

To reduce the issues related to inter-vendor training collaboration, several alternatives have been also proposed, e.g.: Fully standardized reference model (structure+parameters); Standardized reference model structure+Parameter exchange; Dataset exchange; and Reference model exchange. These schemes can be further subclassified when the first node uses the received information directly (or with optimization step(s)) as the encoder model, or the first node further trains the appropriate encoder model using the received information from the other side. Furthermore, the options can be classified based on the exchanged information, e.g., if the information represents the decoder model of the second node or the information represents an encoder model that is a matched with the decoder model of the second node.

Each of these schemes has advantages and disadvantages. For example, schemes that allow the UE to design its encoder potentially can result into models with higher performance, but such schemes may have some overhead and complexity regarding how and where to train the encoder. As another example, exchange of decoder model can be useful for the UE to be able to fine-tune its encoder model and make sure that the encoder model performs correctly, while exchange of the encoder model due to its lower complexity can be implemented to potentially use the encoder model as the UE encoder. Direct application of the encoder for the UE also has the drawback that the UE is not able to determine if the encoder is actually working correctly for a current condition.

The present disclosure provides solutions for solving the inter-vendor training collaboration issue and determine the performance of a selected encoder/decoder pair before execution. Further, this disclosure presents alternatives to determine the correct encoder model which is a correct match with the decoder model which will be used at the NE side. It is noted that although we have presented an example use case for feeding-back the CSI information, the proposed scheme in this disclosure can be applied to a variety of different two-sided models.

In the present disclosure and considering a two-sided model, we use [symbol] to refer to the complete model while Mₑ and M_{d} are referring to the UE side (first node-side) of the model and the NE side (second node-side) of the model, respectively. With this notation, the UE uses Mₑ for encoding of the input data xᵢ, transmits the encoded data zᵢ=Mₑ (xᵢ), through the channel H, and then gNB decode the received message yᵢ (in some examples, the received message yᵢ may be pre-processed e.g., channel equalization, detection, and/or error-correction/detection channel decoding) using M_{d} and determines the output Oᵢ=M_{d} (yᵢ). Note that the proposed implementations are also applicable to the scenario where the roles of the UE and NE are reversed with a two-sided model, e.g., the encoder, Mₑ, model is performed at the NW (e.g., gNB) and the decoder, M_{d}, model is performed at the UE—the NW is the first node, and the UE is the second node.

The following disclose may use UE/UE-side and instead of the second node use NE/gNB/NW/NW-side, but implementations are not limited to such scenarios. Further, it may be considered that a NE side has already trained decoder models denoted by [symbol] _{d1}, . . . , [symbol] _{dK} fine-tuned for different datasets, configurations, network, and/or UE conditions or different statistics of input data. The second node (NE) may also have access to these decoders. Note that this assumption includes the case where the NE side only has one decoder model, and the NE may be able to down select between the available decoder model based on the current configuration and/or network or UE conditions.

In some implementations and other than the decoder models, the NE side may also have access to a version of the encoder model, e.g., NW-side-encoder-model, denoted by [symbol] ₑ₁, . . . , [symbol] _{eK}. The NW-side-encoder-model can be trained in accordance with the corresponding trained decoder model, and therefore can be considered as the correct encoder model for that decoder model. The NW-side-encoder-model can be for example constructed during the training of the decoder model based on NW-first Type-3 training.

There are different cases where the NE and the UE may need to initiate the process of encoder/decoder determination and/or update. This step is usually needed to make sure that the models used for inference match the current NE and/or the UE condition/state/input statistics. Some examples that this process might be initiated include: The first node (e.g., UE) determines to connect to and/or hand-over to the NE; the UE or the NE observes and/or is notified of a change in the UE or NE state or the statistics of the input data; and/or the UE or the NE observes and/or is notified of low performance of a model currently in use, for example based on the model monitoring scheme.

Also in some other examples the NE may query the UE whether the UE supports a configuration/variation of a functionality, but the UE may not have that information (for example the matching model) readily available for that configuration/variation. This may lead to initiation of the process of encoder/decoder determination and/or update. As another example, the process of encoder/decoder determination and/or update may be initiated when the NE configures the UE for particular configuration, but the UE may not have the model for that configuration. The NE and UE may determine if they can support that configuration/variation of a functionality.

The present disclosure presents options for the process of determining the correct encoder/decode model.

In implementations a model validity check process can be initiated at the second node, e.g., NE. In such implementations, the NE may use different information elements to down select from the set of available decoder models. Examples of such information elements include the current configuration, network or UE conditions, TCI and QCL information, statistics of the input data as delay spread, doppler shift, information regarding the identity of the UE, etc. In implementations [symbol] _{d1}, . . . , [symbol] _{dL} represent the selected decoder models from the set of all available models (i.e., [symbol] _{d1}, . . . , [symbol] _{dk}) and the corresponding NW-side-encoder-model can be denoted by [symbol] ₑ₁, . . . , [symbol] _{eL}.

In implementations the UE measures/generates/determines a set of test data composed of the input of the two-sided model and if needed their corresponding expected output, denoted by Xₜ={ [symbol] x₁, o₁ [symbol] , . . . , [symbol] xₛ, oₛ [symbol] } for the current state of the UE/NE. Note that in some cases oᵢ may not be included in the set of test data as the NE may already have access to oᵢ, oᵢ can be calculated based on xᵢ, and/or oᵢ can be equal to xᵢ. The test data also may include some other information regarding the input data or UE condition, e.g., TCI and QCL information, statistics of the input data as delay spread, doppler shift.

In implementations the UE can transmit the set of test data to a NE and the NE uses the set of test data to evaluate the performance of different pairs of NW-side-encoder-model and/or decoder model, e.g., ( [symbol] ₑᵢ, [symbol] _{di}), i={1, 2, . . . , L}. The NE may use other information received from the UE to determine which model is a better fit. For example, if the models have the meta information regarding model(s) are appropriate for which delay spread or QCL, the NE can use this information for model selection.

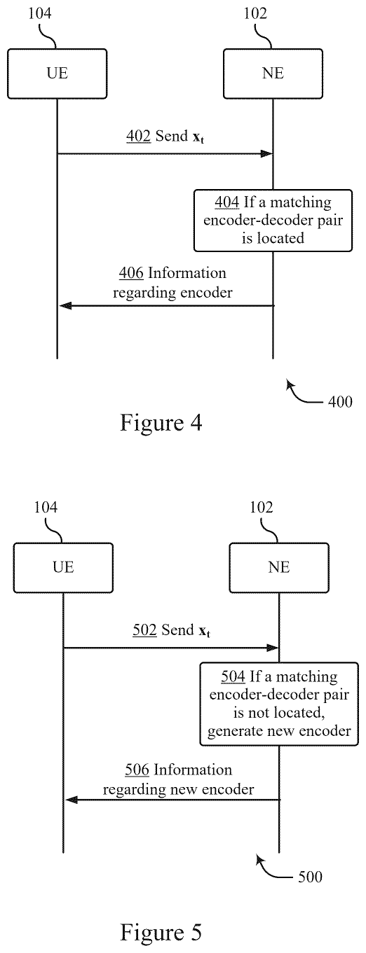

FIG. 4 illustrates an example signaling diagram 400 in accordance with aspects of the present disclosure. In the signaling diagram 400, at 402 the UE 104 transmits test data Xt to a NE 102, and if at 404 a matching encoder-decoder pair is located, at 406 the NE 102 transmits to the UE 104 information regarding the encoder. The NE, for instance, finds an encoder/decoder pair (e.g., ( [symbol] _{eq}, [symbol] _{dq}) has a good match with the set of test data, e.g., the output of that two-sided model has a good match with the expected output, e.g., the average similarity is greater than a threshold. The NE can then decide to use [symbol] _{dq} as the decoder for the UE (first node). The NE can transmit to the UE/UE-side the information regarding the corresponding NW-side-encoder-model, e.g., [symbol] _{eq}. The UE can receive the information regarding the NW-side-encoder-model and utilize the corresponding encoder model and/or with model optimization (e.g., quantization) as the encoder model. In implementations the UE can use the encoder model to train/update another encoder model and use the trained encoder model as the encoder.

In some implementations a NE may not be successful in identifying a matching encoder/decoder pair, such as based on test data from a UE. For instance, the NE may not identify an encoder/decoder pair matching the set of test data, e.g., a similarity between the output of available models and the expected output are less than a threshold.

FIG. 5 illustrates an example signaling diagram 500 in accordance with aspects of the present disclosure. In the signaling diagram 500, at 502 the UE 104 transmits test data xₜ to the NE 102, and if at 504 a matching encoder-decoder pair is not located, at 506 the NE 102 transmits to the UE 104 information regarding a new encoder. Thus, a new encoder/decoder pair can be generated. The NE can determine (e.g., train/fine-tune from another pair) another pair of NW-side-encoder-model, decoder model (e.g., ( [symbol] _{e(L+1)}, [symbol] _{d(L+1)}) based on the new set of test data and optionally a subset of previous data obtained by the NE. The NE may also query the UE for additional samples.

In some implementations, the NE may determine to restrict [symbol] _{d(L+1)} to use one of the already existing decoder models, e.g., [symbol] _{d1}, . . . , [symbol] _{dK}. If the NE is able to develop a two-sided model with acceptable performance, the NE can consider the pair of ( [symbol] _{e(L+1)}, [symbol] _{d(L+1)}) as the selected model and follow the steps of described above with reference to the signaling diagram 400. If the NE is not able to develop a two-sided model with acceptable performance, the NE may try another decoder model (e.g., if the NE has restricted the design of the decoder model) or may decide to determine that an AI/ML scheme cannot be used for this UE.

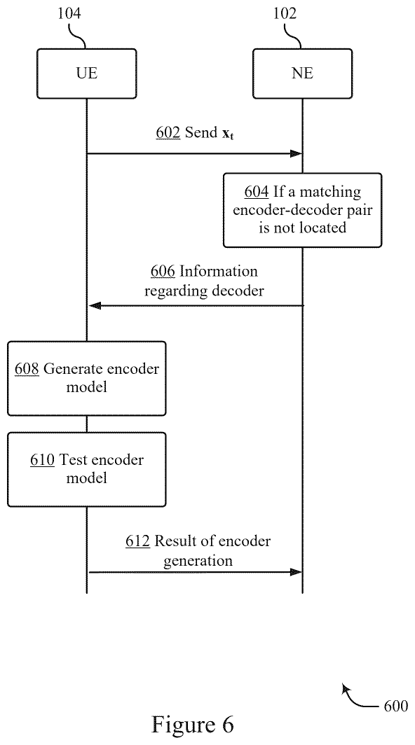

FIG. 6 illustrates an example signaling diagram 600 in accordance with aspects of the present disclosure. In the signaling diagram 600, at 602 the UE 104 transmits test data xₜ to the NE 102, and if at 604 a matching encoder-decoder pair is not located, at 606 the NE 102 transmits to the UE 104 information regarding decoder at the NE. The NE, for instance, sends information regarding a reference decoder [symbol] _{d} model to the UE. The reference decoder model, for instance, can be based on one of the [symbol] _{d1}, . . . , [symbol] _{dK} (e.g., the decoder of the two-sided model that has the best performance for the set of test data) and/or based on another default decoder model (e.g., [symbol] _{d0}) that is available at the NE. The NE, for instance, trains the default decoder model using all the data so the model likely has the best generalization capability.

Further to the signaling diagram 600, at 608 the UE 104 can generate an encoder model (e.g., based on the information regarding decoder from 606), at 610 can test the generated encoder model, and at 612 can transmit a result of the encoder generation to the NE 102, e.g., whether the UE was able to generate an encoder model with performance that achieve a threshold. The UE, for instance, can use the information received for the reference decoder model and determine (e.g., train/fine-tune from another pair) another pair of encoder and reference decoder model (e.g., (Mₑ, [symbol] _{d}) based on the set of test data and other samples available at the UE.

If the UE is able to develop a two-sided model with acceptable performance, the UE can use Mₑ as the encoder model and notify the NE that the training was successful. The NE can use [symbol] _{d} (or its equivalent model) as the decoder model for the UE. If the UE was not able to develop a two-sided model with acceptable performance, the UE can notify the NE that no encoder could be generated. The NE may send another reference decoder model or may decide to declare that not possible to use an AI/ML scheme for the UE.

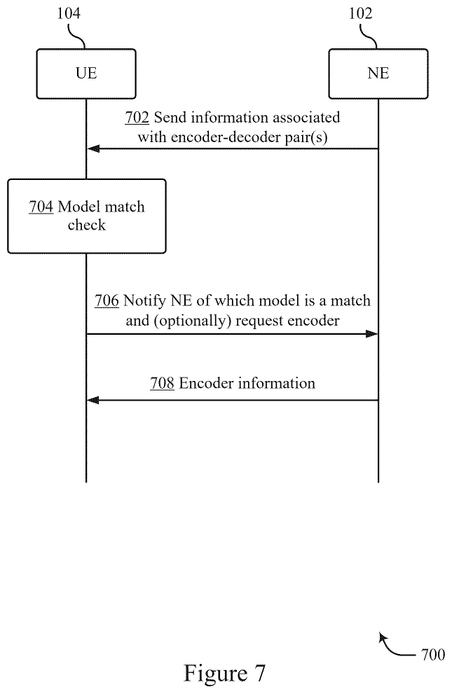

FIG. 7 illustrates an example signaling diagram 700 in accordance with aspects of the present disclosure. In the signaling diagram 700, at 702 the NE 102 sends to the UE 104 information associated with one or more encoder/decoder pairs and at 704 the UE 104 performs an encoder model match check based on the received encoder/decoder pairs. At 706 the UE 104 can notify the NE 102 of which encoder model is successfully matched or optionally, request an encoder/encoder information. At 708 the NE 102 can send encoder information to the UE 104.

In implementations the NE may use different information elements to down select from the set of all available decoder models (i.e., [symbol] _{d1}, . . . , [symbol] _{dK}). Examples of such information elements include the current configuration, network or UE conditions, TCI and QCL information, statistics of the input data as delay spread, doppler shift, information regarding the identity of the UE. In examples assume that [symbol] _{d1}, . . . , [symbol] _{dL} represent the selected decoder models. The corresponding NW-side-encoder-model can be denoted by [symbol] ₑ₁, . . . , [symbol] _{eL}.

The NE then send a set of information to the UE 104 (e.g., first node) regarding these “L” models which can be used to determine if that model is applicable for the current state. Examples of such information include: E1: A NN model which obtains the current input (e.g., currently measured) and determines which of the “L” (or “K”) models may be a best fit; E2: “L” different NN models, where each of the models can check how well the current input can be matched with each of the selected models. For example, each of these NN models could be an outlier detector trained based on the dataset used for training of one of the selected model; E3: A set of datasets that each represent the training dataset used for training of one of the selected models. The UE can use the datasets to determine which dataset is a better match with the current input data; E4: A set of information regarding the statistics of each of datasets used for training of one of the selected models. The UE can the information regarding statistics to determine if any of the datasets are a good match with the current input data; E5: A set of reference encoder-decoder pairs each of which is associated to one of the selected models. The UE can use these reference encoder-decoder models to see if any of the models have acceptable performance with respect to the current input. Note that in some implementation the reference encoder and/or reference decoder may be [symbol] ₑᵢ and [symbol] _{di}. The NE may also send other information regarding each model, e.g., TCI and QCL information, statistics of the input data as delay spread, doppler shift that the model is trained for.

In implementations the UE can measure/generate/determine a set of test data using the received a set of information and determine if a selected model is a match. For example, the UE can determine if outlier models output a low value for the test data and/or if the set of test data has similar statistics with the representative datasets received from the NE, e.g., Earth Mover's Distance, Maximum Mean Discrepancy, etc. The UE may use other information received from the NE to determine which model is a better fit for the current state. For example, the UE can compare the QCL state or delay spread of the current input with the information received for each model.

In implementations if the UE identifies a model that matches the set of test data (e.g., the fitness value or similarity measure is larger than a threshold), the UE can notify the best model to the NE, for example the q^{th} model. The NE may thus determine to use [symbol] _{dq} as the decoder for the UE. If the UE does not have the corresponding [symbol] _{eq}, the UE may query the NE for information regarding [symbol] _{eq} and the NE may transmit information [symbol] _{eq} to the UE.

In implementations the NE can receive the information regarding the NW-side-encoder-model and the UE may use the model directly or apply optimization to the model (e.g., quantization) as the encoder model. The UE or UE-side can use the model to train/update another model and UE use the trained model as the encoder.

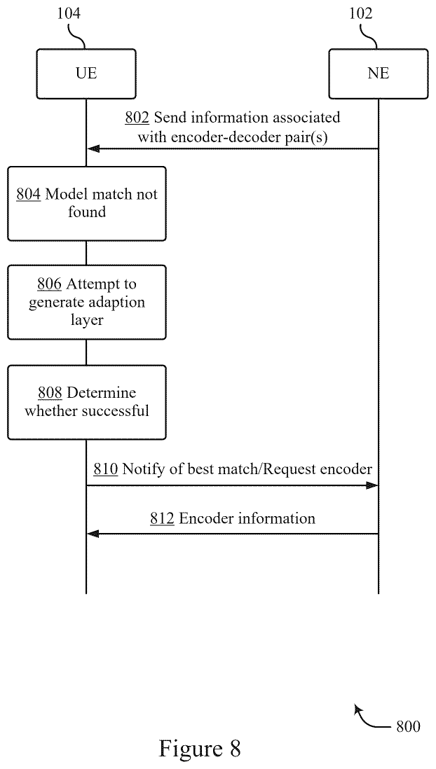

FIG. 8 illustrates an example signaling diagram 800 in accordance with aspects of the present disclosure. The signaling diagram 800, for example, illustrates examples where the UE cannot identify an encoder model that has a suitable match with the set of test data, e.g., the fitness value is larger than a threshold. In the signaling diagram 800, at 802 the NE 102 sends to the UE 104 information associated with one or more encoder-decoder pairs and at 804 the UE 104 determines that an encoder model is not identified as a match, e.g., does not exhibit a match threshold. At 806 the UE 104 attempts to generate an adaptation layer and at 808 the UE 104 determines whether the attempt to generate the adaptation layer is successful. At 810 if the UE 104 is able to successfully generate the adaptation layer, the UE 104 notifies the NE 102 which model is a best match and requests an encoder associated with the model (if the UE 104 does not already have the encoder). At 812 the NE 102 (optionally) sends the UE 104 information about the requested encoder.

For example, in such implementations the UE 104 can develop an adaptation layer for a new encoder-decoder pair. The UE can attempt to determine the adaptation module (e.g., a NN block) M_{adapt} trying to match the test data (input data) for at least one of the “L” models, for example the q^{th} model. For example, if the UE has information of type E3 and E4 (above), the UE can attempt to determine the adaptation module that modifies the test data (input data) to be a better match for at least one of such information. The UE can indicate the best match model to the NE (for example the q^{th} model) and the NE can determine to use [symbol] _{dq} as the decoder for the UE. If the UE does not have the corresponding [symbol] _{eq}, the UE can query the NE for information regarding [symbol] _{eq} and the NE can transmit information [symbol] _{eq} to the UE. Accordingly, receiving the information regarding the NW-side-encoder-model from the NE, the UE can use the adaptation module and the indicated model directly and/or with applied optimization (e.g., quantization) as the encoder model. The UE or UE-side can then use the resulting model to train/update another model and use the adaptation module and the trained model as the encoder.

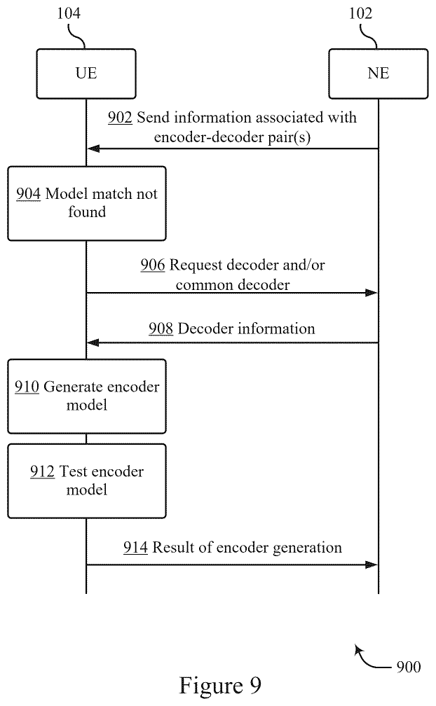

FIG. 9 illustrates an example signaling diagram 900 in accordance with aspects of the present disclosure. In the signaling diagram 900, at 902 the NE 102 sends to the UE 104 information associated with one or more encoder-decoder pairs and at 904 the UE 104 determines that an encoder model is not identified as a match, e.g., does not exhibit a match threshold. At 906 the UE 104 requests from the NE 102 a decoder and/or a common decoder and at 908 the NE 102 sends to the UE 104 decoder information. At 910 the UE 104 generates an encoder model based on the received decoder information, at 912 the UE 104 tests the generated encoder model, and at 914 the UE 104 sends to the NE 102 a result of the generated encoder testing.

For instance, in implementations the UE queries the NE for the decoder model of one the models, for example the q^{th} model, e.g., to enable the UE to determine which one the models may have a better match with the test data. The NE can send to the UE information regarding a reference decoder, [symbol] _{d}, which can be based on based on the requested [symbol] _{dq}. The UE can use the received information for the reference decoder model and determine (e.g., train/fine-tune from another pair) another pair of encoder-reference decoder model (e.g., (Mₑ, [symbol] _{d}) based on the set of test data and other samples available at the UE.

If the UE can generate a two-sided model with acceptable performance, the UE can use Mₑ as the encoder model and notify the NE that the training was successful and the NE can use [symbol] _{d} (or its equivalent model) as the decoder model for the UE. If the UE was not able to generate a two-sided model with acceptable performance, the UE can notify the NE that no encoder could be successfully generated. The NE can then perform various actions, such as send the UE another reference decoder model, send the UE another default decoder model (e.g., [symbol] _{d0} that is available at the NE, and/or determine that an AI/L scheme cannot be used with the UE.

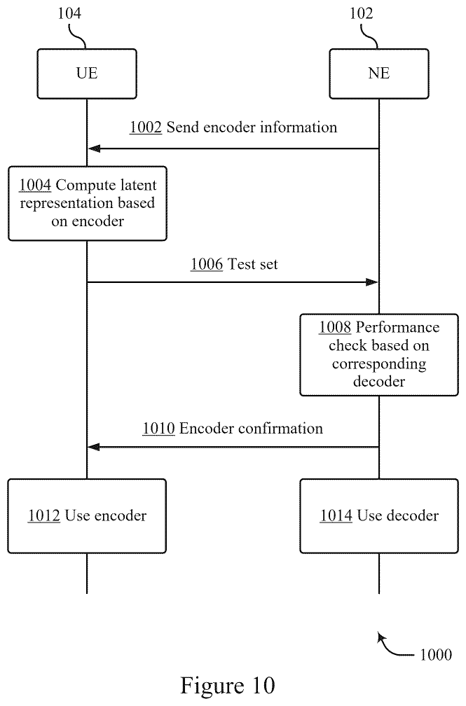

FIG. 10 illustrates an example signaling diagram 1000 in accordance with aspects of the present disclosure. In the signaling diagram 1000, at 1002 the NE 102 can send encoder information to the UE 104 and at 1004 the UE 104 can compute a latent representation based at least in part on the encoder information. At 1006 the UE 104 can send a set of test data to the NE 102 and at 1008 the NE 102 can use the set of test data to perform a performance check on a corresponding decoder. Based at least in part on the performance check, the at 1010 the NE 102 can send to the UE 104 an encoder confirmation message. At 1012 the UE 104 can utilize the encoder for encoding data and at 1014 the NE 102 can utilize the corresponding decoder for decoding encoded data.

In implementations, the NE may use different information elements to down select from the set of all available decoder models (i.e., [symbol] _{d1}, . . . , [symbol] _{dK}). Examples of such information elements include the current configuration, network or UE conditions, TCI and QCL information, statistics of the input data as delay spread, Doppler shift, information regarding the identity of the UE, etc.

In implementations [symbol] _{d1}, . . . , [symbol] _{dL} represent the selected decoder models. The corresponding NW-side-encoder-model can be denoted by [symbol] ₑ₁, . . . , [symbol] _{eL}. The NE may have access to another decoder model [symbol] _{d0} (and its corresponding NW-side-encoder-model can be denoted by [symbol] ₑ₀) where the model has been trained using a different dataset, e.g., combination of all or subset of dataset used for training of each model. The NE can select one of the decoders (e.g., a corresponding NW-side-encoder-model, e.g., q or alternatively or additionally [symbol] _{d0} or [symbol] ₑ₀) and send information regarding the NW-side-encoder-model to the UE, [symbol] _{eq}.

Receiving the information regarding the NW-side-encoder-model, the UE can use the model directly and/or optimize the model (e.g., with quantization) for the encoder model. The UE or UE-side can use the model to train/update another model and use the trained model as the encoder. The term [symbol] ₑ can refer to the encoder. The UE can encode the set of current input, Xₜₑₛₜ={x₁, . . . , xₚ}, using [symbol] ₑ, and generate the encoded data, Zₜ. The UE can send test data (Zₜ, Oₜ) to the NE/NW-side, where Oₜ is the set of expected output corresponding to Xₜ. In examples the test data may include information regarding the input data and/or UE condition, e.g., TCI and QCL information, statistics of the input data as delay spread, doppler shift, etc. The NE/NW-side may test a similarity between Oₜ and [symbol] _{dq}(Zₜ) and the NE may use information received from the UE to determine which model is a better fit. For example, if the models have the meta information on which of them are appropriate for which delay spread or QCL, the NE can use this information for model selection. In examples where a high similarity is determined, the NE can send the confirmation message to the UE to continue using that encoder and the NE can use Mag as the decoder model for the UE.

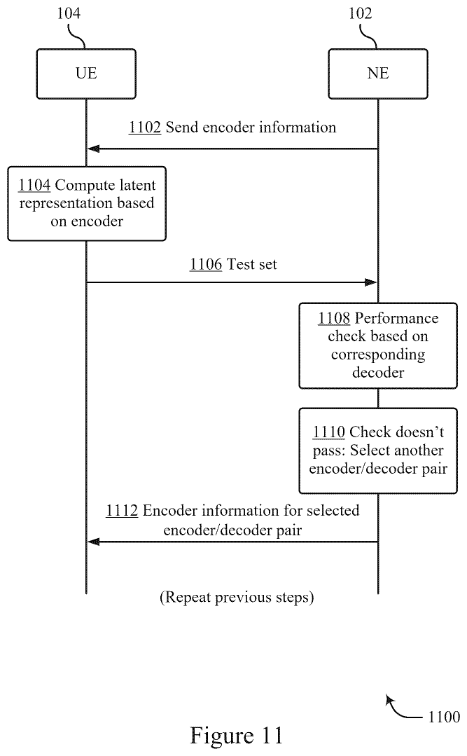

FIG. 11 illustrates an example signaling diagram 1100 in accordance with aspects of the present disclosure. In the signaling diagram 1100, at 1102 the NE 102 can send encoder information to the UE 104 and at 1104 the UE 104 can compute a latent representation based at least in part on the encoder information. At 1106 the UE 104 can send a set of test data to the NE 102 and at 1108 the NE 102 can use the set of test data to perform a performance check on a corresponding decoder. Based at least in part on the performance check not being successful, at 1110 the NE 102 can select a different encoder-decoder pair. At 1112 the NE 102 can send to the UE 104 encoder information for the different encoder-decoder pair. For instance, the NE can select another encoder/decoder model and send the corresponding encoder moder to the UE and repeat the previous steps. For example, the NE can use the received set of (Zₜ, Oₜ) to test which decoder model is a better match, e.g., higher similarity between Oₜ and [symbol] _{di}(Zₜ).

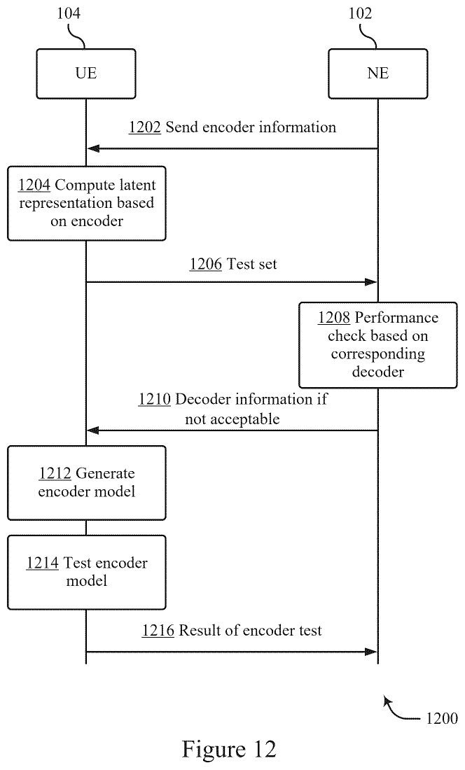

FIG. 12 illustrates an example signaling diagram 1200 in accordance with aspects of the present disclosure. In the signaling diagram 1200, at 1202 the NE sends to the UE 104 encoder information and at 1204 the UE 104 computes a latent representation based at least in part on the encoder information. At 1206 the UE 104 can send a set of test data to the NE 102 and at 1208 the NE 102 can use the set of test data to perform a performance check on a corresponding decoder. If the performance check indicates that the performance of the corresponding decoder is not acceptable, at 1210 the NE 102 sends information regarding the decoder to the UE 104 and at 1212 the UE 104 utilizes the information to generate a corresponding encoder model. At 1214 the UE 104 tests the generated encoder model and at 1216 the UE 104 sends to the NE 102 a result of the encoder test.

For instance, in implementations the NE sends to the UE information regarding reference decoder model [symbol] _{d} which is based at least in part on the decoder model of the previously sent encoder, e.g., [symbol] _{dq}. The UE uses the information received for the decoder model and determines (e.g., trains/fine-tunes from another pair) another pair of encoder, reference decoder models (e.g., (Mₑ, [symbol] _{d}) based on the set of test data and other data samples available at the UE. If the UE develops a two-sided model with acceptable performance (e.g., high similarity between Oₜ and [symbol] _{d}(Mₑ (Xₜ))), the UE uses Mₑ as the encoder model can notify the NE that the training was successful. The NE can then use [symbol] _{d} ( [symbol] _{dq}) (or its equivalent model) as the decoder model for the UE. If the UE was not able to develop a two-sided model with acceptable performance, the UE can notify the NE that an encoder was not successfully generated, and the NE can send another encoder model or may decide to determine an AI/ML scheme cannot be utilized for the UE.

The following represent some details that can be applied in the various cases discussed herein. In implementations, transmission/transfer of information regarding one model from a first node to a second node can take place in different forms, such as the following.

Assuming that the structure of that model is standardized or already known at the second node: Sending parameters of the model (only weights, only structure, both weights and structure); sending a dataset using which the second node can determine the parameters of the model; and/or sending an identifier to the second node using which the second node can determine/obtain/recover the parameters of the model or a dataset from another node or from the set of parameters/dataset accessible to the second node.

Assuming that the structure of that model is not known at the second node: Sending model structure and its parameters; sending a dataset using which the second node can determine the parameters of the model; and/or sending an identifier to the second node using which the second node can determine/obtain/recover the structure of the model, the parameters of the model, or a dataset from another node or from the set of structures, parameters, or datasets accessible to the second node.

In implementations, transmission/transfer of information regarding one model may indicate that the information (model structure/parameters or the dataset) represents an actual model itself or that the information (model structure/parameters or the dataset) represents a second model which is generated to have similar behaviour of the actual model.

In implementations the similarity of two set of vectors can be determined based on the use case. For example the similarity between set 1 of {a₁, a₂, . . . , aₙ} and the corresponding vectors set-2 of {b₁, b₂, . . . , bₙ} can be defined based on the average Euclidian distance between aᵢ and bᵢ, or can be based on the average cosine-similarity of between aᵢ and bᵢ. If the vectors of set-1 and set-2 do not have one-to-one correspondence, then the similarity of the two set can be determined based on other approaches like Earth Mover's Distance or Maximum Mean Discrepancy. In some cases, the fitness value represents how much a sample/sample set has the same similarity to another set. There can be models (e.g., outlier detection models) the output of which indicates a similarity of the input data to a dataset that the outlier-detection-model is trained for and can represent the fitness of this input data for an AI/ML model which is trained using this dataset. In some implementations, a fitness value represents a similarity value between a sample/set to another set or a value for a match between a sample data set and the statistics of data that a model is trained with.

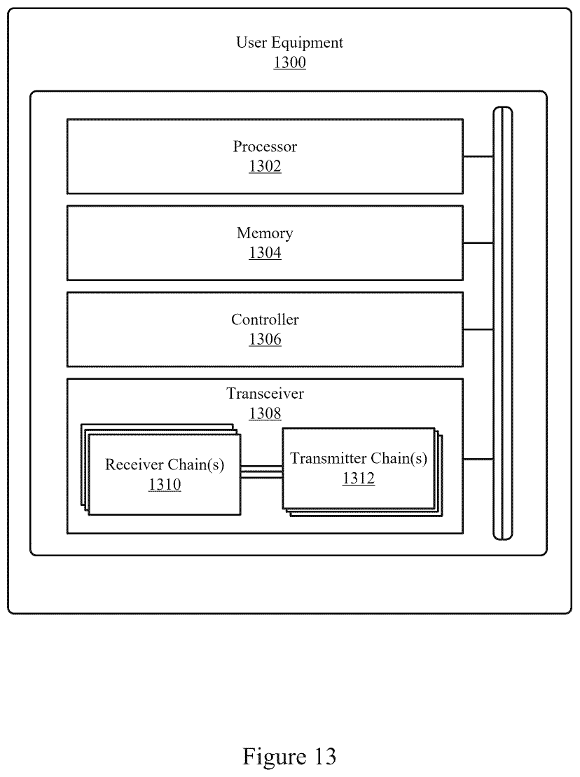

FIG. 13 illustrates an example of a UE 1300 in accordance with aspects of the present disclosure. The UE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the UE 1300 to perform various functions of the present disclosure.

The memory 1304 may include volatile or non-volatile memory. The memory 1304 may store computer-readable, computer-executable code including instructions when executed by the processor 1302 cause the UE 1300 to perform various functions described herein. The code may be stored in a non-transitory computer-readable medium such as the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the UE 1300 to perform one or more of the functions described herein (e.g., executing, by the processor 1302, instructions stored in the memory 1304). For example, the processor 1302 may support wireless communication at the UE 1300 in accordance with examples as disclosed herein. The UE 1300 may be configured to or operable to support a means for transmitting a set of test data including at least one of statistics of input data for an encoder model of the UE, a first set of samples of the input data, or a second set of samples representing an expected output of a two-sided artificial intelligence model associated with the first set of samples of the input data; receiving a first set of information associated with a first reference artificial intelligence model, where the first reference artificial intelligence model is associated with one or more of a decoder model of a two-sided artificial intelligence model or an encoder model of the two-sided artificial intelligence model; and performing a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.

Additionally, the UE 1300 may be configured to support any one or combination of if the first reference artificial intelligence model is associated with the encoder model of the two-sided artificial intelligence model, the method further includes performing the process to obtain the encoder model of the UE based at least in part on the first set of information associated with the first reference artificial intelligence model; if the first reference artificial intelligence model is associated with the decoder model of the two-sided artificial intelligence model, the method further including performing the process to obtain the encoder model of the UE based at least in part on the first set of information associated with the first reference artificial intelligence model and the input data for the encoder model of the UE; transmitting an indication of whether the UE successfully obtains the encoder model; if the UE is not able to successfully obtain the encoder model of the UE, the method further includes: receiving a second set of information associated with a second reference artificial intelligence model associated with a different decoder model; and performing the process to obtain the encoder model of the UE based at least in part on the second set of information and the input data; if the UE is not able to successfully obtain the encoder model of the UE, the method further includes receiving a message indicating an inability to train an encoder-decoder pair.

Additionally, the UE 1300 may be configured to support any one or combination of if the UE is not able to successfully obtain the encoder model of the UE, the method further includes receiving a message including an instruction to implement a fallback process; performing measurements of a radio channel, and wherein the input data is associated with the measurements of the radio channel; the input data includes at least one of a representation of a measured channel matrix of a radio channel or a precoder for the radio channel; the first set of information includes one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples; performing the process to obtain the encoder model of the UE based at least in part on one or more of an instruction received from a different node or a different process executed at the UE.

Additionally, the UE 1300 may be configured to or operable to support a means for receiving a set of information associated with at least one encoder-decoder pair of a two-sided artificial intelligence models; performing, based at least in part on the set of information associated with the encoder-decoder pairs, a verification process to determine whether a matching encoder model is available; and transmitting at least a notification of a result of the verification process.

Additionally, the UE 1300 may be configured to or operable to support a means for receiving information associated with an encoder model for an encoder-decoder pair of a two-sided artificial intelligence model; generating a latent representation based at least in part on the information associated with an encoder model; transmitting test data generated via the latent representation and a corresponding expected output of the two-sided artificial intelligence model; and receiving at least a notification indicating whether to continue to use the encoder model or use an alternative implementation.

Additionally, or alternatively, the UE 1300 may support at least one memory (e.g., the memory 1304) and at least one processor (e.g., the processor 1302) coupled with the at least one memory and configured to cause the UE to transmit a set of test data including at least one of statistics of input data for an encoder model of the UE, a first set of samples of the input data, or a second set of samples representing an expected output of a two-sided artificial intelligence model associated with the first set of samples of the input data; receive a first set of information associated with a first reference artificial intelligence model, where the first reference artificial intelligence model is associated with one or more of a decoder model of a two-sided artificial intelligence model or an encoder model of the two-sided artificial intelligence model; and perform a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.

Additionally, the UE 1300 may be configured to support any one or combination of if the first reference artificial intelligence model is associated with the encoder model of the two-sided artificial intelligence model, the at least one processor is configured to cause the UE to perform the process to obtain the encoder model of the UE based at least in part on the first set of information associated with the first reference artificial intelligence model; if the first reference artificial intelligence model is associated with the decoder model of the two-sided artificial intelligence model, the at least one processor is configured to cause the UE to perform the process to obtain the encoder model of the UE based at least in part on the first set of information associated with the first reference artificial intelligence model and the input data for the encoder model of the UE; the at least one processor is configured to cause the UE to transmit an indication of whether the UE successfully obtains the encoder model; if the UE is not able to successfully obtain the encoder model of the UE, the at least one processor is configured to cause the UE to: receive a second set of information associated with a second reference artificial intelligence model associated with a different decoder model; and perform the process to obtain the encoder model of the UE based at least in part on the second set of information and the input data; if the UE is not able to successfully obtain the encoder model of the UE, the at least one processor is configured to cause the UE to receive a message indicating an inability to train an encoder-decoder pair.

Additionally, the UE 1300 may be configured to support any one or combination of if the UE is not able to successfully obtain the encoder model of the UE, the at least one processor is configured to cause the UE to receive a message including an instruction to implement a fallback process; the at least one processor is configured to cause the UE to perform measurements of a radio channel, and wherein the input data is associated with the measurements of the radio channel; the input data includes at least one of a representation of a measured channel matrix of a radio channel or a precoder for the radio channel; the first set of information includes one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples; the at least one processor is configured to cause the UE to perform the process to obtain the encoder model of the UE based at least in part on one or more of an instruction received from a different node or a different process executed at the UE.

Additionally, or alternatively, the UE 1300 may support at least one memory (e.g., the memory 1304) and at least one processor (e.g., the processor 1302) coupled with the at least one memory and configured to cause the UE to receive a set of information associated with at least one encoder-decoder pair of a two-sided artificial intelligence models; perform, based at least in part on the set of information associated with the encoder-decoder pairs, a verification process to determine whether a matching encoder model is available; and transmit at least a notification of a result of the verification process.

Additionally, or alternatively, the UE 1300 may support at least one memory (e.g., the memory 1304) and at least one processor (e.g., the processor 1302) coupled with the at least one memory and configured to cause the UE to receive information associated with an encoder model for an encoder-decoder pair of a two-sided artificial intelligence model; generate a latent representation based at least in part on the information associated with an encoder model; transmit test data generated via the latent representation and a corresponding expected output of the two-sided artificial intelligence model; and receive at least a notification indicating whether to continue to use the encoder model or use an alternative implementation.

The controller 1306 may manage input and output signals for the UE 1300. The controller 1306 may also manage peripherals not integrated into the UE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the UE 1300 may include at least one transceiver 1308. In some other implementations, the UE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas to receive a signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

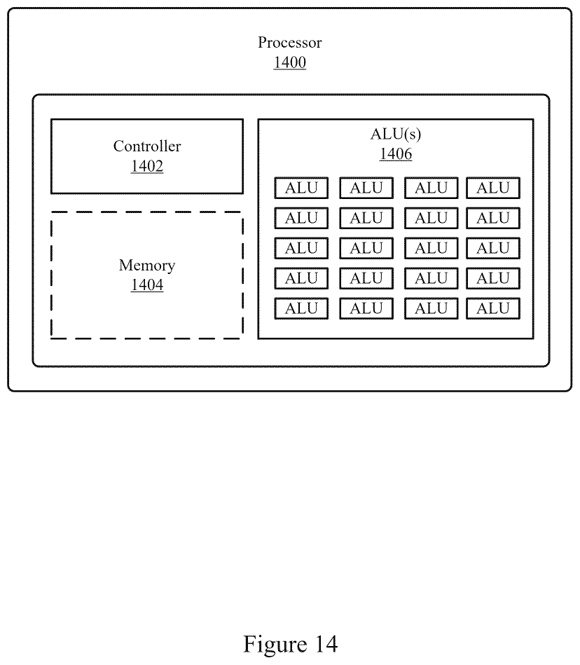

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory addresses of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage flow of data within the processor 1400. The controller 1402 may be configured to control transfer of data between registers, ALUs 1406, and other functional units of the processor 1400.

The memory 1404 may include one or more caches (e.g., memory local to or included in the processor 1400 or other memory, such as RAM, ROM, DRAM, SDRAM, SRAM, MRAM, flash memory, etc. In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, and the controller 1402, and may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 may be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

The processor 1400 may support wireless communication in accordance with examples as disclosed herein. The processor 1400 may be configured to or operable to support at least one controller (e.g., the controller 1402) coupled with at least one memory (e.g., the memory 1404) and configured to cause the processor to transmit a set of test data including at least one of statistics of input data for an encoder model of a UE, a first set of samples of the input data, or a second set of samples representing an expected output of a two-sided artificial intelligence model associated with the first set of samples of the input data; receive a first set of information associated with a first reference artificial intelligence model, where the first reference artificial intelligence model is associated with one or more of a decoder model of a two-sided artificial intelligence model or an encoder model of the two-sided artificial intelligence model; and perform a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.

Additionally, the processor 1400 may be configured to or operable to support any one or combination of if the first reference artificial intelligence model is associated with the encoder model of the two-sided artificial intelligence model, the at least one controller is configured to cause the processor to perform the process to obtain the encoder model of the UE based at least in part on the first set of information associated with the first reference artificial intelligence model; if the first reference artificial intelligence model is associated with the decoder model of the two-sided artificial intelligence model, the at least one controller is configured to cause the processor to perform the process to obtain the encoder model of the UE based at least in part on the first set of information associated with the first reference artificial intelligence model and the input data for the encoder model of the UE; t the at least one controller is configured to cause the processor to transmit an indication of whether the processor successfully obtains the encoder model; if the processor is not able to successfully obtain the encoder model of the UE, the at least one controller is configured to cause the processor to: receive a second set of information associated with a second reference artificial intelligence model associated with a different decoder model; and perform the process to obtain the encoder model of the UE based at least in part on the second set of information and the input data; if the processor is not able to successfully obtain the encoder model of the UE, the at least one controller is configured to cause the processor to receive a message indicating an inability to train an encoder-decoder pair.

Additionally, the processor 1400 may be configured to or operable to support any one or combination of if the processor is not able to successfully obtain the encoder model of the UE, the at least one controller is configured to cause the processor to receive a message including an instruction to implement a fallback process; the at least one controller is configured to cause the processor to perform measurements of a radio channel, and wherein the input data is associated with the measurements of the radio channel; the input data includes at least one of a representation of a measured channel matrix of a radio channel or a precoder for the radio channel; the first set of information includes one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples; the at least one controller is configured to cause the processor to perform the process to obtain the encoder model of the UE based at least in part on one or more of an instruction received from a different node or a different process executed at the UE.

The processor 1400 may be configured to or operable to support at least one controller (e.g., the controller 1402) coupled with at least one memory (e.g., the memory 1404) and configured to cause the processor to receive a set of information associated with at least one encoder-decoder pair of a two-sided artificial intelligence models; perform, based at least in part on the set of information associated with the encoder-decoder pairs, a verification process to determine whether a matching encoder model is available; and transmit at least a notification of a result of the verification process.

The processor 1400 may be configured to or operable to support at least one controller (e.g., the controller 1402) coupled with at least one memory (e.g., the memory 1404) and configured to cause the processor to receive information associated with an encoder model for an encoder-decoder pair of a two-sided artificial intelligence model; generate a latent representation based at least in part on the information associated with an encoder model; transmit test data generated via the latent representation and a corresponding expected output of the two-sided artificial intelligence model; and receive at least a notification indicating whether to continue to use the encoder model or use an alternative implementation.

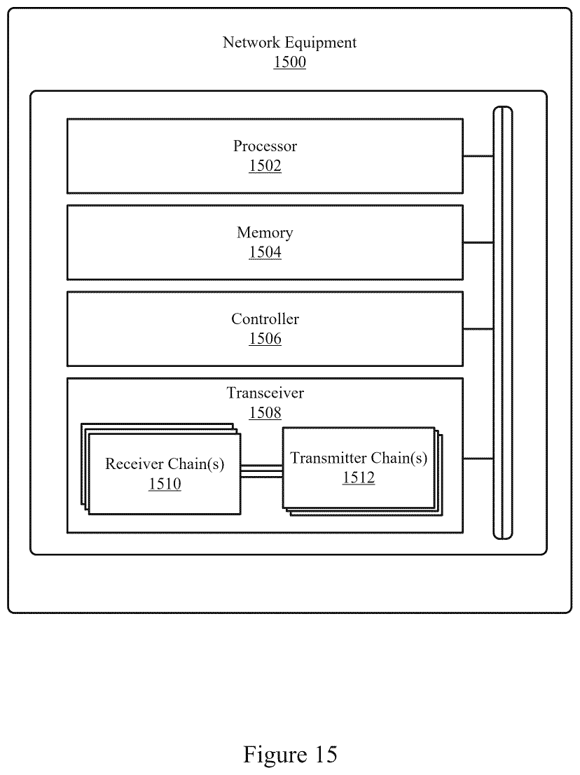

FIG. 15 illustrates an example of a NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code including instructions when executed by the processor 1502 cause the NE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the NE 1500 to perform one or more of the functions described herein (e.g., executing, by the processor 1502, instructions stored in the memory 1504). For example, the processor 1502 may support wireless communication at the NE 1500 in accordance with examples as disclosed herein. The NE 1500 may be configured to or operable to support a means for receiving a set of test data including at least one of statistics of input data for an encoder model of a UE, a first set of samples of the input data, or a second set of samples representing an expected output of a two-sided artificial intelligence model associated with the first set of samples of the input data; and transmitting, based at least in part on the set of test data, a first set of information associated with a first reference artificial intelligence model, where the first reference artificial intelligence model is associated with one or more of a decoder model of a two-sided artificial intelligence model or an encoder model of the two-sided artificial intelligence model.

Additionally, the NE 1500 may be configured to or operable to support any one or combination of receiving an indication of whether the UE is able to successfully obtain the encoder model; if the indication indicates that the UE is not able to successfully obtain the encoder model, the method further includes transmitting a second set of information associated with a second reference artificial intelligence model associated with a different decoder model; if the indication indicates that the UE is not able to successfully obtain the encoder model, the method further includes transmitting a message indicating an inability to train an encoder-decoder pair; if the indication indicates that the UE is not able to successfully obtain the encoder model, the method further includes transmitting a message including an instruction to implement a fallback process; the first set of information includes one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples; transmitting, to the UE, an instruction to perform a process to obtain the encoder model of the UE.

The NE 1500 may be configured to or operable to support a means for transmitting a set of information associated with at least one encoder-decoder pair of a two-sided artificial intelligence model; and receiving at least a notification of a result of a verification process for an encoder model and the information associated with the encoder-decoder pair.

The NE 1500 may be configured to or operable to support a means for transmitting information associated with an encoder model for an encoder-decoder pair of a two-sided artificial intelligence model; receiving test data generated via a latent representation and the corresponding expected output of the two-sided model; and transmitting at least a notification indicating whether to continue to use the encoder model or use an alternative implementation.

Additionally, or alternatively, the NE 1500 may support at least one memory (e.g., the memory 1504) and at least one processor (e.g., the processor 1502) coupled with the at least one memory and configured to cause the NE to receive a set of test data including at least one of statistics of input data for an encoder model of a UE, a first set of samples of the input data, or a second set of samples representing an expected output of a two-sided artificial intelligence model associated with the first set of samples of the input data; and transmit, based at least in part on the set of test data, a first set of information associated with a first reference artificial intelligence model, where the first reference artificial intelligence model is associated with one or more of a decoder model of a two-sided artificial intelligence model or an encoder model of the two-sided artificial intelligence model.

Additionally, the NE 1500 may be configured to support any one or combination of where the at least one processor is configured to cause the network equipment to receive an indication of whether the UE is able to successfully obtain the encoder model; if the indication indicates that the UE is not able to successfully obtain the encoder model, the at least one processor is configured to cause the network equipment to transmit a second set of information associated with a second reference artificial intelligence model associated with a different decoder model; if the indication indicates that the UE is not able to successfully obtain the encoder model, the at least one processor is configured to cause the network equipment to transmit a message indicating an inability to train an encoder-decoder pair; if the indication indicates that the UE is not able to successfully obtain the encoder model, the at least one processor is configured to cause the network equipment to transmit a message including an instruction to implement a fallback process; the first set of information includes one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples; the at least one processor is configured to cause the network equipment to transmit, to the UE, an instruction to perform a process to obtain the encoder model of the UE.

Additionally, or alternatively, the NE 1500 may support at least one memory (e.g., the memory 1504) and at least one processor (e.g., the processor 1502) coupled with the at least one memory and configured to cause the NE to transmit a set of information associated with at least one encoder-decoder pair of a two-sided artificial intelligence model; and receive at least a notification of a result of a verification process for an encoder model and the information associated with the encoder-decoder pair.

Additionally, or alternatively, the NE 1500 may support at least one memory (e.g., the memory 1504) and at least one processor (e.g., the processor 1502) coupled with the at least one memory and configured to cause the NE to transmit information associated with an encoder model for an encoder-decoder pair of a two-sided artificial intelligence model; receive test data generated via a latent representation and the corresponding expected output of the two-sided model; and transmit at least a notification indicating whether to continue to use the encoder model or use an alternative implementation.

The controller 1506 may manage input and output signals for the NE 1500. The controller 1506 may also manage peripherals not integrated into the NE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

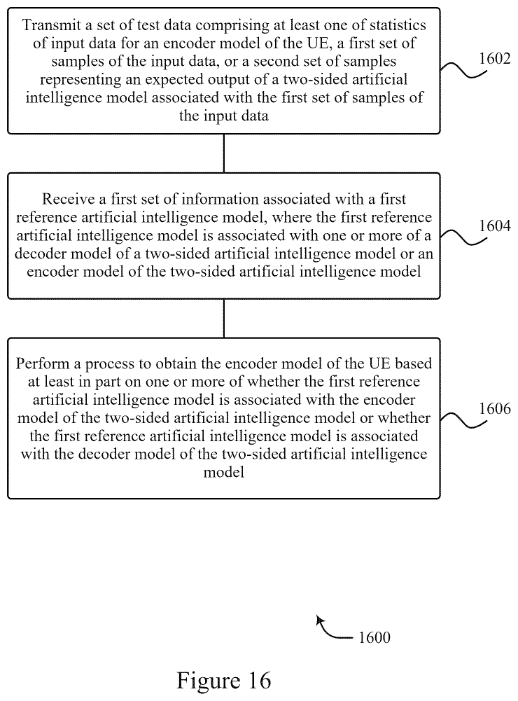

FIG. 16 illustrates a flowchart of a method 1600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1602, the method may include transmitting a set of test data comprising at least one of statistics of input data for an encoder model of the UE, a first set of samples of the input data, or a second set of samples representing an expected output of a two-sided artificial intelligence model associated with the first set of samples of the input data. The operations of 1602 may be performed in accordance with examples as described herein. In some implementations, aspects of the operations of 1602 may be performed by a UE as described with reference to FIG. 13.

At 1604, the method may include receiving a first set of information associated with a first reference artificial intelligence model, where the first reference artificial intelligence model is associated with one or more of a decoder model of a two-sided artificial intelligence model or an encoder model of the two-sided artificial intelligence model. The operations of 1604 may be performed in accordance with examples as described herein. In some implementations, aspects of the operations of 1604 may be performed by a UE as described with reference to FIG. 13.

At 1606, the method may include performing a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model. The operations of 1606 may be performed in accordance with examples as described herein. In some implementations, aspects of the operations of 1606 may be performed a UE as described with reference to FIG. 13.

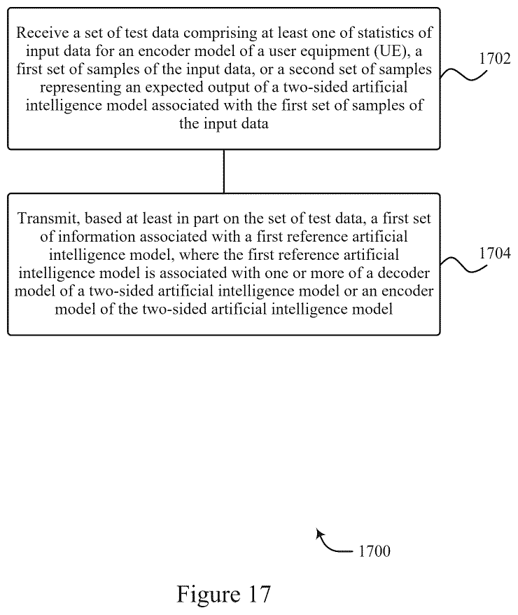

FIG. 17 illustrates a flowchart of a method 1700 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1702, the method may include receiving a set of test data comprising at least one of statistics of input data for an encoder model of a UE, a first set of samples of the input data, or a second set of samples representing an expected output of a two-sided artificial intelligence model associated with the first set of samples of the input data. The operations of 1702 may be performed in accordance with examples as described herein. In some implementations, aspects of the operations of 1702 may be performed by a NE as described with reference to FIG. 15.

At 1704, the method may include transmitting, based at least in part on the set of test data, a first set of information associated with a first reference artificial intelligence model, where the first reference artificial intelligence model is associated with one or more of a decoder model of a two-sided artificial intelligence model or an encoder model of the two-sided artificial intelligence model. The operations of 1704 may be performed in accordance with examples as described herein. In some implementations, aspects of the operations of 1704 may be performed by a NE as described with reference to FIG. 15.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
transmit a set of test data comprising at least one of statistics of input data for an encoder model of the UE, a first set of samples of the input data, or a second set of samples representing an expected output of a two-sided artificial intelligence model associated with the first set of samples of the input data;
receive a first set of information associated with a first reference artificial intelligence model, where the first reference artificial intelligence model is associated with one or more of a decoder model of a two-sided artificial intelligence model or an encoder model of the two-sided artificial intelligence model; and
perform a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.

2. The UE of claim 1, wherein if the first reference artificial intelligence model is associated with the encoder model of the two-sided artificial intelligence model, the at least one processor is configured to cause the UE to perform the process to obtain the encoder model of the UE based at least in part on the first set of information associated with the first reference artificial intelligence model.

3. The UE of claim 1, wherein if the first reference artificial intelligence model is associated with the decoder model of the two-sided artificial intelligence model, the at least one processor is configured to cause the UE to perform the process to obtain the encoder model of the UE based at least in part on the first set of information associated with the first reference artificial intelligence model and the input data for the encoder model of the UE.

4. The UE of claim 1, wherein the at least one processor is configured to cause the UE to transmit an indication of whether the UE successfully obtains the encoder model.

5. The UE of claim 4, wherein if the UE is not able to successfully obtain the encoder model of the UE, the at least one processor is configured to cause the UE to:
receive a second set of information associated with a second reference artificial intelligence model associated with a different decoder model; and
perform the process to obtain the encoder model of the UE based at least in part on the second set of information and the input data.

6. The UE of claim 4, wherein if the UE is not able to successfully obtain the encoder model of the UE, the at least one processor is configured to cause the UE to receive a message indicating an inability to train an encoder-decoder pair.

7. The UE of claim 4, wherein if the UE is not able to successfully obtain the encoder model of the UE, the at least one processor is configured to cause the UE to receive a message comprising an instruction to implement a fallback process.

8. The UE of claim 1, wherein the at least one processor is configured to cause the UE to perform measurements of a radio channel, and wherein the input data is associated with the measurements of the radio channel.

9. The UE of claim 1, wherein the input data comprises at least one of a representation of a measured channel matrix of a radio channel or a precoder for the radio channel.

10. The UE of claim 1, wherein the first set of information comprises one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples.

11. The UE of claim 1, wherein the at least one processor is configured to cause the UE to perform the process to obtain the encoder model of the UE based at least in part on one or more of an instruction received from a different node or a different process executed at the UE.

12. A processor for wireless communication, comprising:
at least one controller coupled with at least one memory and configured to cause the processor to:
transmit a set of test data comprising at least one of statistics of input data for an encoder model of a user equipment (UE), a first set of samples of the input data, or a second set of samples representing an expected output of a two-sided artificial intelligence model associated with the first set of samples of the input data;
receive a first set of information associated with a first reference artificial intelligence model, where the first reference artificial intelligence model is associated with one or more of a decoder model of a two-sided artificial intelligence model or an encoder model of the two-sided artificial intelligence model; and
perform a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.

13. A network equipment for wireless communication, comprising:
at least one memory; and
at least one processor coupled with the at least one memory and configured to cause the network equipment to:
receive a set of test data comprising at least one of statistics of input data for an encoder model of a user equipment (UE), a first set of samples of the input data, or a second set of samples representing an expected output of a two-sided artificial intelligence model associated with the first set of samples of the input data; and
transmit, based at least in part on the set of test data, a first set of information associated with a first reference artificial intelligence model, where the first reference artificial intelligence model is associated with one or more of a decoder model of a two-sided artificial intelligence model or an encoder model of the two-sided artificial intelligence model.

14. The network equipment of claim 13, wherein the at least one processor is configured to cause the network equipment to receive an indication of whether the UE is able to successfully obtain the encoder model.

15. The network equipment of claim 14, wherein if the indication indicates that the UE is not able to successfully obtain the encoder model, the at least one processor is configured to cause the network equipment to transmit a second set of information associated with a second reference artificial intelligence model associated with a different decoder model.

16. The network equipment of claim 14, wherein if the indication indicates that the UE is not able to successfully obtain the encoder model, the at least one processor is configured to cause the network equipment to transmit a message indicating an inability to train an encoder-decoder pair.

17. The network equipment of claim 14, wherein if the indication indicates that the UE is not able to successfully obtain the encoder model, the at least one processor is configured to cause the network equipment to transmit a message comprising an instruction to implement a fallback process.

18. The network equipment of claim 13, wherein the first set of information comprises one or more of a set of parameters representing one or more weights of a neural network model, a set of parameters representing a structure of the neural network model, a set of samples representing an input/output of the neural network model, or one or more identifiers associated with at least one of model parameters, model structure, or an associated set of samples.

19. The network equipment of claim 13, wherein the at least one processor is configured to cause the network equipment to transmit, to the UE, an instruction to perform a process to obtain the encoder model of the UE.

20. A method performed by a user equipment (UE), the method comprising:
transmitting a set of test data comprising at least one of statistics of input data for an encoder model of the UE, a first set of samples of the input data, or a second set of samples representing an expected output of a two-sided artificial intelligence model associated with the first set of samples of the input data;
receiving a first set of information associated with a first reference artificial intelligence model, where the first reference artificial intelligence model is associated with one or more of a decoder model of a two-sided artificial intelligence model or an encoder model of the two-sided artificial intelligence model; and
performing a process to obtain the encoder model of the UE based at least in part on one or more of whether the first reference artificial intelligence model is associated with the encoder model of the two-sided artificial intelligence model or whether the first reference artificial intelligence model is associated with the decoder model of the two-sided artificial intelligence model.
